(19) United States
(12) Patent Application Publication
(10) Pub. No.: US 2012/0092002 A1
(43) Pub. Date: Apr. 19, 2012

(54) SENSOR ARRANGEMENT FOR DETERMINING THE CURRENT ROTATION ANGLE POSITION OF A SHAFT

(75) Inventors: Thomas KLEEGREWE, Minden (DE); Stefan Engelke, Haste (DE); Stephan Schulze, Buckeburg (DE)

(73) Assignee: ABB Technology AG, Zurich (CH)

(21) Appl. No.: 13/223,748

(22) Filed: Sep. 1, 2011

(30) Foreign Application Priority Data
Sep. 1, 2010 (DE) 202010012071.3

(51) Int. Cl. G01B 7/30

(52) U.S. Cl. 324/207.16

(57) ABSTRACT

A sensor arrangement is provided for determining the current rotation angle position of a shaft with respect to a stationary reference point. In order to determine the rotation angle position without wear and tear and with little outlay on materials and little energy requirement during ongoing operation, the coil is arranged between the shaft and a stationary reference point in such a manner that at least one geometrical property of the coil can be changed over the range of rotation angle positions of the shaft. The changed geometrical property of the coil is used to determine the rotation angle position of the shaft.

### RELATED APPLICATION

This application claims priority under 35 U.S.C. §119 to German Patent Application No. 202010012071.3 filed in Germany on Sep. 1, 2010, the entire content of which is hereby incorporated by reference in its entirety.

### FIELD

The present disclosure relates to a sensor arrangement for determining the current rotation angle position of a shaft with respect to a stationary reference point. The sensor arrangement of the present disclosure can be utilized in a variety of applications including, for example, in electropneumatic or purely electrical position controller units for actuating drives or variable-speed drives.

### BACKGROUND INFORMATION

Various position determination methods which are each encumbered with individual disadvantages are known. For instance, the practice of determining the rotation angle position of a shaft with the aid of a potentiometer has the disadvantage of the susceptibility of the latter to wear and tear. Incremental encoders are expensive and require, for the associated processing means, amounts of energy which are not available in loop-fed automation devices. The practice of buffering the energy supply from batteries is complicated and has little acceptance among users.

In order to avoid wear and tear on parts of the sensor arrangement which move relative to one another, the aim is to contactlessly measure the rotation angle position of a shaft. A technical solution for contactlessly determining the current rotation angle position of a shaft is disclosed in DE 44 15 686 A1. In this case, the shaft is mounted in such a manner that it is both axially displaceable and rotatable and can assume defined axial positions and rotation angle positions. A displacement sensor is arranged parallel to the shaft and interacts with a permanent magnet fastened on the shaft side. In this case, the special permanent magnet is fastened to the periphery of the shaft in such a manner that the longitudinal direction of the magnet runs along a helix, with the result that both the axial displacement of the shaft and its rotation result in different positions of that part of the permanent magnet which is effective for the displacement sensor.

Inductive displacement sensors are also known and operate according to the following principle. A resonant circuit is detuned by the approach of a magnetically conductive material or a change in the coil inductance by changing the position of a ferrite rod inside the coil. The mechanical properties of the coil remain unchanged in this case.

Swiss Engineering STZ, March 2010 edition, page 20, discloses the practice of using the restoring springs of a joystick as inductive sensors.

### SUMMARY

An exemplary embodiment of the present disclosure provides a sensor arrangement for determining a current rotation angle position of a shaft. The exemplary sensor arrangement includes a shaft, and a coil arranged between the shaft and a stationary reference point such that at least one geometrical property of the coil is configured to be changed over a range of rotation angle positions of the shaft. The inductance of the coil is a measure of the rotation angle position of the shaft.

### BRIEF DESCRIPTION OF THE DRAWINGS

Additional refinements, advantages and features of the present disclosure are described in more detail below with reference to exemplary embodiments illustrated in the drawings, in which:

FIG. 1 shows an illustration of an exemplary embodiment for determining the current rotation angle position of a shaft with a lever;

FIG. 2 shows an illustration of an exemplary embodiment for determining the current rotation angle position of a shaft with an eccentric disk; and

FIG. 3 shows an illustration of an exemplary embodiment for determining the current rotation angle position of a shaft with a coil subjected to torsional loading.

### DETAILED DESCRIPTION

Exemplary embodiments of the present disclosure are based on the concept of determining the rotation angle position of a shaft with respect to a stationary reference point without wear and tear and with little outlay on materials and little energy requirement during ongoing operation.

Exemplary embodiments of the present disclosure provide a sensor arrangement for determining the current rotation angle position of a shaft with respect to a stationary reference point using a coil, where the inductance of the coil is a measure of the rotation angle position of the shaft.

In accordance with an exemplary embodiment of the present disclosure, the coil is arranged between the shaft and a stationary reference point in such a manner that at least one geometrical property of the coil can be changed over the range of rotation angle positions of the shaft.

As generally known, the inductance L of a coil is proportional to the square of its number of turns N, to its cross section A and to the reciprocal of its length l.

L˜N²*A/l.

Any change in the parameters of the number of turns N, cross section A and length l results in a change in the inductance L. The inductance L of the coil is determined with the aid of any known measuring circuit of sufficient accuracy. In accordance with an exemplary embodiment, the coil is part of a resonant circuit, where the inductance and deformation of the coil are proportional to one another.

Strictly speaking, the equation for the inductance L:

L=N²*μ₀*μᵣ*A/l

applies only to a slender cylindrical air-core coil with the absolute permeability constant μ₀ and the relative permeability constant μᵣ.

In this case, any deviation from the structural shape of the slender air-core coil gives rise to a change in the inductance with parameters which otherwise remain the same.

The elastic deformation of the spring, as caused by a change in the rotation angle, results in a proportional change in the inductance. This is recorded and preprocessed using electronics. A rotation angle position of the shaft is thus assigned to each recorded inductance.

In accordance with an exemplary embodiment of the present disclosure, the sensor arrangement advantageously has a low weight in conjunction with a low physical volume and is distinguished by a low outlay on material, production and maintenance. In addition, the exemplary sensor arrangement according to the present disclosure is free of wear and tear.

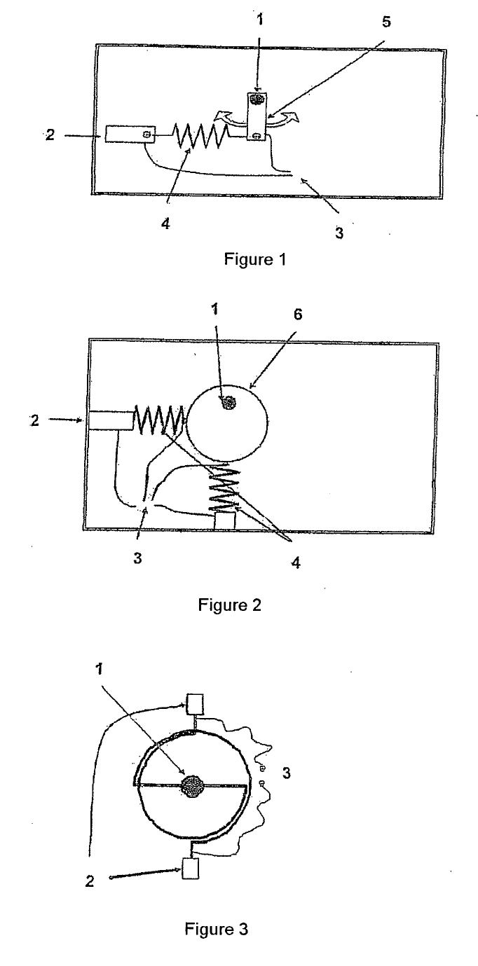

FIG. 1 shows an illustration of an exemplary embodiment for determining the current rotation angle position of a shaft 1 with a lever 5. The lever 5 is radially connected to the shaft 1 in a housing 2. A substantially cylindrical air-core coil 4 is arranged between that end of the lever 5 which is remote from the shaft 1 and a fixed reference point of the housing 2, and is stretched or compressed as a result of any change in the rotation angle position of the shaft 1.

In accordance with an exemplary embodiment, the winding of the coil 4 can be wound from a spring material, for example. In this case, the cylindrical shape of the coil 4 can be retained over the stretching and compression operations.

The inductance of the coil 4 changes on the basis of the rotation angle position of the shaft 1. The coil 4 is connected to an electronic circuit via connecting lines 3 at the ends of its winding. In accordance with an exemplary embodiment, the coil 4 is part of a resonant circuit, the frequency of which is detuned in proportion with the change in the inductance of the coil 4. The inductance of the coil 4 and thus the frequency of the resonant circuit are accordingly a measure of the rotation angle position of the shaft 1.

FIG. 2 illustrates an exemplary embodiment of the disclosure. In this case, a sensor arrangement for determining the current rotation angle position of a shaft 1 with an eccentric disk 6 is illustrated. The shaft 1 is provided, in a housing, with an eccentric disk 6, on the circumferential surface of which the winding ends of two coils 4 end, which are arranged substantially at right angles to one another in the plane of the eccentric disk 6 and whose ends which are remote from the shaft are each connected to a fixed reference point of the housing 2.

In accordance with an exemplary embodiment, the coils 4 are in the form of substantially cylindrical air-core coils. The windings of the coils 4 are wound from a spring material, for example. The coils 4 are in the form of a compression spring. The coils 4 are stretched or relaxed when the shaft 1 is rotated and thus when the rotation angle position changes. The geometrical length of each coil 4 changes in this case anyway. In addition, the geometrical shape of each coil 4 changes on the basis of the rigidity of the spring material of the windings. The original cylindrical shape is toroidally deformed in this case. Both changes in the coil geometry give rise, and thus also in combination, to a change in the inductance of the respective coil 4.

In accordance with an exemplary embodiment, the coils 4 are connected to an electronic circuit via connecting lines 3 at the ends of their winding. For example, the coils 4 are parts of resonant circuits, the frequencies of which are detuned in proportion with the changes in the inductances of the coils 4. The inductances of the coils 4 and thus the frequencies of the resonant circuits are accordingly measures of the rotation angle position of the shaft 1.

The exemplary embodiment illustrated in FIG. 2 allows for both the detection of the rotation angle position of the shaft 1 over one full revolution and the detection of the direction of rotation of the shaft 1.

FIG. 3 shows an exemplary embodiment of the disclosure. In this case, a sensor arrangement for determining the current rotation angle position of a shaft 1 with a coil subjected to torsional loading is illustrated. The shaft 1 axially penetrates a cylindrical coil in a housing. In this case, as illustrated, provision may be made for the winding of the coil to have a central radial web which is connected to the shaft 1 rigidly in terms of rotation and for the winding ends of the coil to each be connected to a fixed reference point of the housing 2. Alternatively, provision may be made for one winding end of the coil to be connected to the shaft 1 rigidly in terms of rotation and for the other end of the winding to be connected to a fixed reference point of the housing. In both these configurations, the rotation of the shaft 1 gives rise at least to a change in the winding diameter. In addition, the number of turns of the coil is also changed and the square thereof is included in the inductance.

The coil is connected to an electronic circuit via connecting lines 3 at the ends of its winding. For example, the coil is part of a resonant circuit, the frequency of which is detuned in proportion with the change in the inductance of the coil. The inductance of the coil and thus the frequency of the resonant circuit are accordingly a measure of the rotation angle position of the shaft 1.

The exemplary embodiment illustrated in FIG. 3 also allows for both the detection of the rotation angle position of the shaft 1 over one full revolution and the detection of the direction of rotation of the shaft 1.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A sensor arrangement for determining a current rotation angle position of a shaft, the sensor arrangement comprising:
a shaft; and
a coil arranged between the shaft and a stationary reference point such that at least one geometrical property of the coil is configured to be changed over a range of rotation angle positions of the shaft,
wherein the inductance of the coil is a measure of the rotation angle position of the shaft.

2. The sensor arrangement as claimed in claim 1, wherein the coil is in the form of a substantially cylindrical air-core coil.

3. The sensor arrangement as claimed in claim 1, wherein a length of the coil is a measure of the rotation angle position of the shaft.

4. The sensor arrangement as claimed in claim 1, wherein a number of turns of the coil is a measure of the rotation angle position of the shaft.

5. The sensor arrangement as claimed in claim 1, wherein a diameter of the coil is a measure of the rotation angle position of the shaft.

6. The sensor arrangement as claimed in claim 1, wherein a geometrical shape of the coil is a measure of the rotation angle position of the shaft.

7. The sensor arrangement as claimed in claim 1, wherein the combination of at least two geometrical properties of the coil from the group consisting of a length, a number of turns, a diameter and the geometrical shape of the coil is a measure of the rotation angle position of the shaft.

8. The sensor arrangement as claimed in claim 2, wherein a length of the coil is a measure of the rotation angle position of the shaft.

9. The sensor arrangement as claimed in claim 2, wherein a number of turns of the coil is a measure of the rotation angle position of the shaft.

10. The sensor arrangement as claimed in claim 2, wherein a diameter of the coil is a measure of the rotation angle position of the shaft.

11. The sensor arrangement as claimed in claim 2, wherein a geometrical shape of the coil is a measure of the rotation angle position of the shaft.

12. The sensor arrangement as claimed in claim 2, wherein the combination of at least two geometrical properties of the coil from the group consisting of a length, a number of turns, a diameter and the geometrical shape of the coil is a measure of the rotation angle position of the shaft.

13. The sensor arrangement as claimed in claim 1, comprising:
a determination circuit configured to determine an inductance of the coil.

14. The sensor arrangement as claimed in claim 13, wherein the determination circuit comprises a resonant circuit.

15. The sensor arrangement as claimed in claim 2, comprising:
a determination circuit configured to determine an inductance of the coil.

16. The sensor arrangement as claimed in claim 15, wherein the determination circuit comprises a resonant circuit.
